(19) United States
(12) Patent Application Publication
(10) Pub. No.: US 2026/0181726 A1
(43) Pub. Date: Jun. 25, 2026

(54) WIRELESS COMMUNICATION DEVICE AND METHOD

(71) Applicant: MEDIATEK INC., Hsinchu City (TW)

(72) Inventors: Chun-Wei Tseng, Hsinchu City (TW); Yuan-Chin Wen, Hsinchu City (TW)

(21) Appl. No.: 19/202,033

(22) Filed: May 8, 2025

Related U.S. Application Data
(60) Provisional application No. 63/737,838, filed on Dec. 23, 2024.

(51) Int. Cl. H04W 76/40

(52) U.S. Cl. CPC H04W 76/40

(57) ABSTRACT

A wireless communication method and device are provided. Before data transmission between a first wireless communication device and a second wireless communication device, a procedure is triggered so that at least one neighboring wireless communication device collects channel information on a plurality of channels and broadcasts the channel information. In response to receiving the channel information from the at least one neighboring wireless communication device, the first wireless communication device selects a target channel among the plurality of channels according to the channel information. Data transmission between the first wireless communication device and the second wireless communication device is starting on the target channel.

This application claims the benefit of U.S. Provisional Patent application Ser. No. 63/737,838, filed Dec. 23, 2024, the disclosure of which is incorporated by reference herein in its entirety.

### TECHNICAL FIELD

The disclosure relates to a wireless communication device and method.

### BACKGROUND

Mobile phones play important role in people life. Sometimes, there is a need to replace old phones with new phones in mobile stores. This involves mass data transmission between old phones and new phones. But, during phone replacement, data transfer can be slow or unstable when replacing phones in mobile stores, particularly over Wi-Fi. Wi-Fi uses competitive transmission. In a Wi-Fi network, all connected devices share the available bandwidth. This means multiple devices compete for access to the network at the same time. WMM (Wi-Fi Multimedia) is a feature that helps prioritize different types of network traffic. It can allocate bandwidth differently for activities like video streaming, voice calls, and regular data transfer.

When many customers are replacing phones simultaneously, they often need to transfer data from old devices to new ones over Wi-Fi. Because multiple devices are competing for the same bandwidth, the network becomes congested. This congestion leads to unstable or slow data transfer, as some devices may struggle to get enough bandwidth.

Without proper bandwidth management, the Wi-Fi network might slow down, causing frustration for customers and staff.

There needs a wireless communication device and method for addressing the above and other prior problems.

### SUMMARY

According to one embodiment, a wireless communication method is provided. The wireless communication method comprises: before data transmission between a first wireless communication device and a second wireless communication device, triggering a procedure so that at least one neighboring wireless communication device collects channel information on a plurality of channels and broadcasts the channel information; in response to receiving the channel information from the at least one neighboring wireless communication device, selecting, by the first wireless communication device, a target channel among the plurality of channels according to the channel information; and starting data transmission between the first wireless communication device and the second wireless communication device on the target channel.

According to another embodiment, a wireless communication device is provided. The wireless communication device includes: a wireless transceiver module for transmitting and receiving wireless signals; and a controller coupled to and for controlling the wireless transceiver module. The controller is configured for: before data transmission between a first wireless communication device and a second wireless communication device, triggering a procedure so that at least one neighboring wireless communication device collects channel information on a plurality of channels and broadcasts the channel information; in response to receiving the channel information from the at least one neighboring wireless communication device, selecting, by the first wireless communication device, a target channel among the plurality of channels according to the channel information; and starting data transmission between the first wireless communication device and the second wireless communication device on the target channel.

### BRIEF DESCRIPTION OF THE DRAWINGS

FIG. 1 shows a wireless communication device according to one embodiment of the application.

FIG. 2 shows wireless communication according to one embodiment of the application.

FIG. 3A and FIG. 3B show a wireless communication method according to one embodiment of the application.

FIG. 4A shows channel information collection by a station in one embodiment of the application.

FIG. 4B shows channel information collection by an AP in one embodiment of the application.

FIG. 5 shows a wireless communication method according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

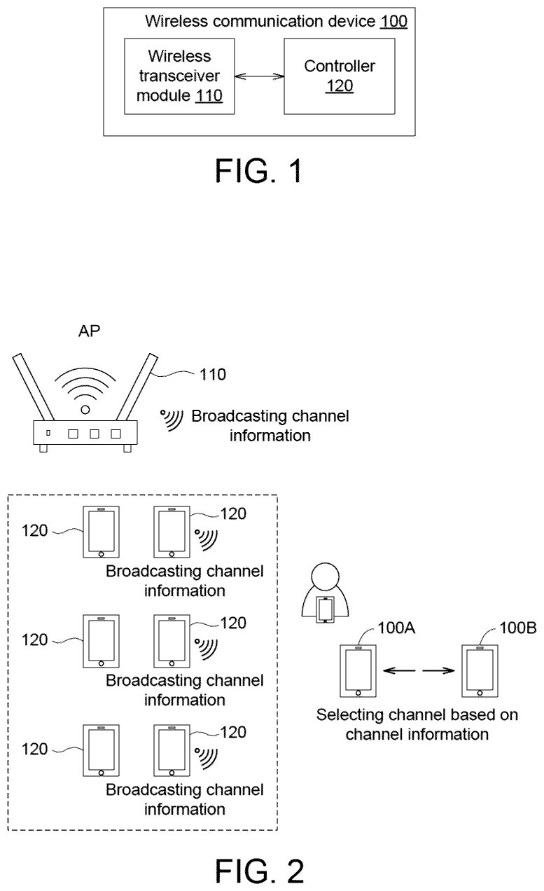

FIG. 1 shows a wireless communication device according to one embodiment of the application. The wireless communication device 100 according to one embodiment of the application includes a wireless transceiver module 110 and a controller 120. The wireless communication device 100 according to one embodiment of the application is for example but not limited by, a station having beamforming function.

The wireless transceiver module 110 is coupled to the controller 120. The wireless transceiver module 110 is for transmitting and receiving wireless signals from other wireless devices.

The controller 120 is for controlling the wireless transceiver module 110 based on the wireless signals received by the wireless transceiver module 110. Further, the controller 120 performs the wireless communication method based on the wireless signals received by the wireless transceiver module 110 and the channel information received from other neighbor wireless communication devices.

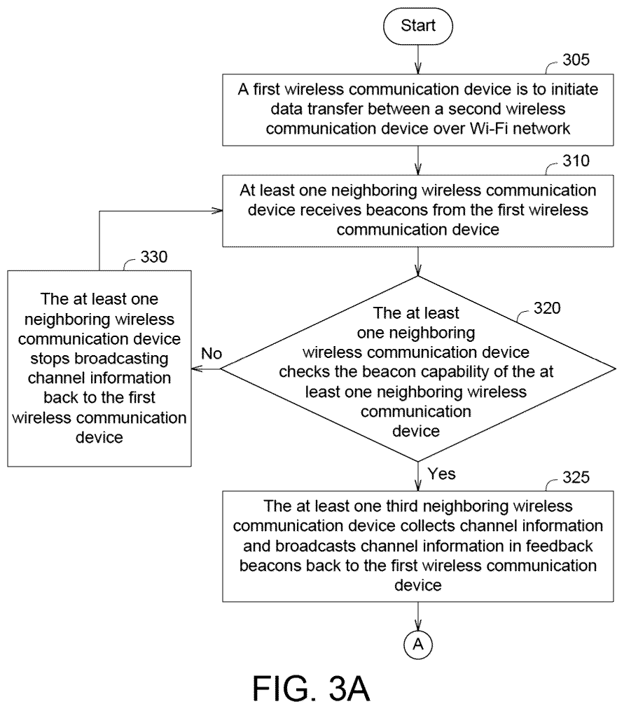

FIG. 2 shows wireless communication according to one embodiment of the application. In FIG. 2, the wireless communication devices 100A and 100B are implemented by the wireless communication device 100 in FIG. 1. There is mass data transmission between the wireless communication devices 100A and 100B. For example but not limited by, during mobile phone replacement, one among the wireless communication devices 100A and 100B is a new mobile phone while the other one the wireless communication devices 100A and 100B is an old mobile phone; and the old mobile phone transmits massive data to the new mobile phone.

During phone replacement, the wireless communication devices 100A and/or 100B need to find a wireless channel (for example but not limited by, Wi-Fi channel) which is not busy, to prevent traffic impact.

One among the wireless communication devices 100A and 100B receives channel information collected by other neighboring wireless communication devices (either AP (access point) 110 or stations (STA) 120) which support “beacon capability”.

Besides initially selecting a cleaner channel, if the channel information changes during the transmission process, the transmission channel can also be changed through the CSA (Channel Switch Announcement) mechanism between the wireless communication devices 100A and 100B by either the wireless communication devices 100A or 100B. By so, this avoids using STA or SAP (soft AP) to collect channel information and thus prevents traffic impact.

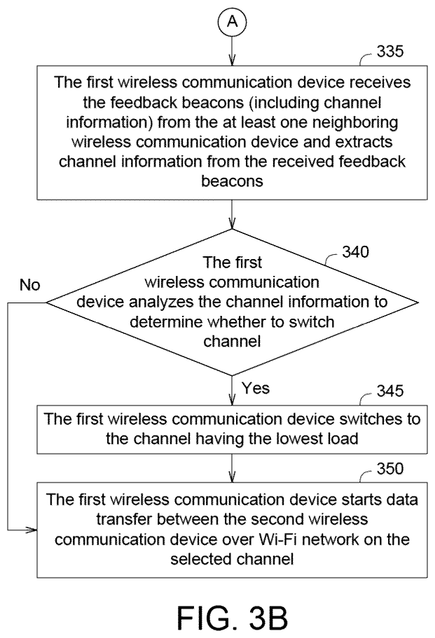

FIG. 3A and FIG. 3B show a wireless communication method according to one embodiment of the application.

In step 305, a first wireless communication device (one among the device 100A and 100B in FIG. 2) is to initiate data transfer between a second wireless communication device (the other one among the device 100A and 100B in FIG. 2) over Wi-Fi network (i.e. wireless network). For example but not limited by, in phone replacement, one among the first wireless communication device and the second wireless communication device is an old phone while the one among the first wireless communication device and the second wireless communication device is a new phone. That is to say, in one embodiment of the application, in phone replacement, either the new phone or the old phone has the ability to initiate data transfer to the other one.

In step 310, at least one neighboring wireless communication device (for example, the device 110 or 120 in FIG. 2) receives beacons from the first wireless communication device. That is to say, in one embodiment of the application, steps 305 and 310 refer that, before data transmission between the first and the second wireless communication devices, the first wireless communication device sends beacons to the at least one neighboring wireless communication device.

In step 320, the at least one neighboring wireless communication device checks the beacon capability of the at least one neighboring wireless communication device. In here, “checking beacon capability” refers to that the at least one neighboring wireless communication device checks whether the at least one neighboring wireless communication device has the ability to include (or carry) channel information into the feedback beacons (or said feedback packets) sending back to the first wireless communication device. When step 320 is yes, the flow proceeds to step 325; and when step 320 is no, the flow proceeds to step 330.

In step 325, the at least one neighboring wireless communication device collects channel information and broadcasts channel information in feedback beacons back to the first wireless communication device.

In step 330, the at least one neighboring wireless communication device stops broadcasting channel information back to the first wireless communication device.

In step 335, the first wireless communication device receives the feedback beacons (including channel information) from the at least one neighboring wireless communication device and extracts channel information from the received feedback beacons.

In step 340, the first wireless communication device analyzes the channel information to determine whether to switch channel. That is, the first wireless communication device analyzes the channel information to determine the current channel is with the lowest load or not. If the first wireless communication device analyzes the channel information and determines that another channel has load lower than the current selected channel, the first wireless communication device decides to switch channel. If yes in step 340, the flow proceeds to step 345; and if no in step 340, the flow proceeds to step 350.

In step 345, the first wireless communication device switches to the channel having the lowest load.

In step 350, the first wireless communication device starts data transfer between the second wireless communication device over Wi-Fi network (i.e. wireless network) on the selected channel.

In the above, although the neighboring wireless communication broadcast the channel information to the first wireless communication device in beacons, the application is not limited by this. In other possible examples, although the neighboring wireless communication broadcast the channel information to the first wireless communication device in action frame packets, or in NAN (Neighbor Awareness Networking) protocol packets or in BT (blue tooth) packets, which are still within the spirit and the scope of the application.

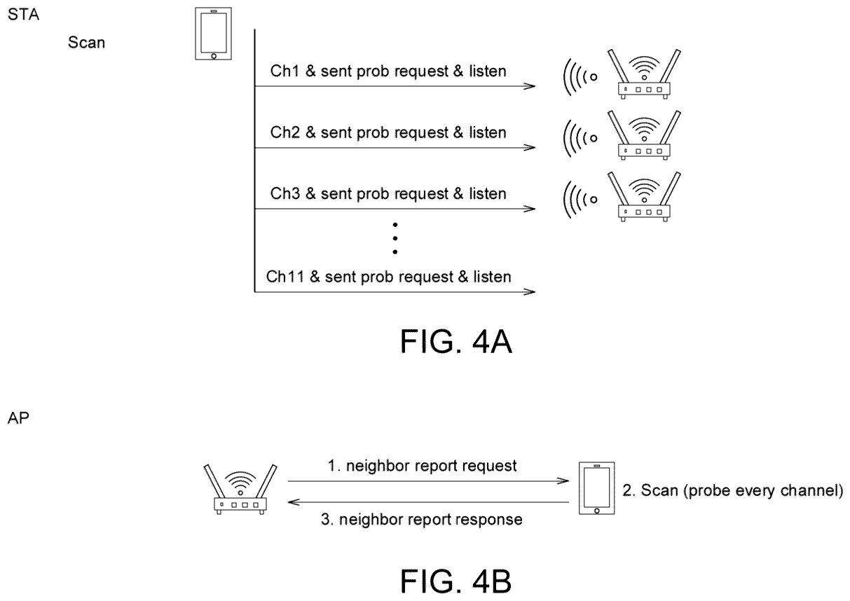

FIG. 4A shows channel information collection by a station in one embodiment of the application. As shown in FIG. 4A, in collecting channel information, the station sends probe request and listens on each channel.

FIG. 4B shows channel information collection by an AP in one embodiment of the application. As shown in FIG. 4A, in collecting channel information, the AP sends neighbor report request to a station (another neighboring wireless communication device). In response to the neighbor report request, the station scans (i.e. probes every channel) and sends neighbor report response to the AP.

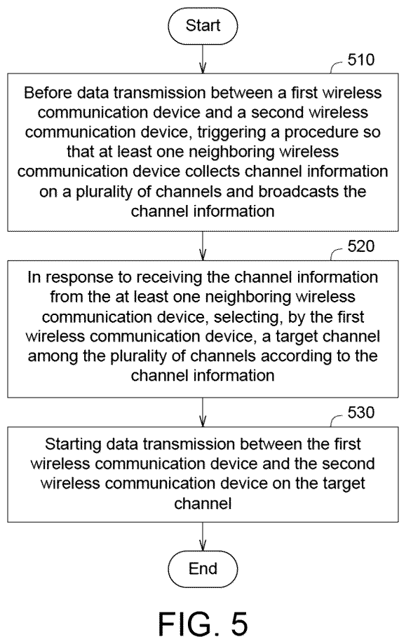

FIG. 5 shows a wireless communication method according to one embodiment of the application. The wireless communication method in FIG. 5 includes: (510) before data transmission between a first wireless communication device and a second wireless communication device, triggering a procedure so that at least one neighboring wireless communication device collects channel information on a plurality of channels and broadcasts the channel information; (520) in response to receiving the channel information from the at least one neighboring wireless communication device, selecting, by the first wireless communication device, a target channel among the plurality of channels according to the channel information; and (530) starting data transmission between the first wireless communication device and the second wireless communication device on the target channel.

In one embodiment of the application, real-time monitoring of channel changes is achieved without affecting the original transmission channel. It dynamically selects the Wi-Fi channel with the lowest load for large data transfers, thereby improving transmission efficiency. In the wireless communication method and device of one embodiment of the application, two devices (for example a new phone and an old phone) can simultaneously leave and switch to a new channel without relying on the AP determination. The application can achieve the purpose of exchanging information through means such as beacons, action frames, NAN protocol, or even blue-tooth, etc.

In one embodiment of the application, channel information is collected from neighboring wireless communication devices (which having the ability to include the channel information into feedback packets (beacons), wherein the neighboring wireless communication devices are either AP or STA) and then broadcast channel information to the device initiating data transmission. Besides initially selecting a cleaner channel, if the channel information changes during the transmission process, the transmission channel can also be changed through the CSA mechanism by the first wireless communication device. This avoids using STA or SAP (soft AP) to collect channel information, preventing traffic impact.

The above primarily describes the solutions provided in the embodiments of the present application from the perspective of wireless communication and channel information collection. Professionals in the technical field can easily recognize that the units and algorithm steps described in the embodiments of the present application can be implemented in hardware form or a combination of hardware and software. Whether the functions performed by hardware or by hardware driven by software depend on the specific application and design constraints of the technical solution. Professionals in the technical field can use different methods to implement the functions described in each specific application without departing from the scope of the present application.

In one embodiment of the present application, the wireless communication device can be divided into functional modules based on the aforementioned method examples. For instance, each functional module can be obtained by dividing according to each corresponding function, or two or more functions can be integrated into one processing module. The integrated module can be implemented in hardware form or as a software functional module. It should be noted that in the embodiments of the present application, the division into modules is merely an example and is a logical function division. In the actual implementation process, other division methods can be used.

While many specific details have been described in this case, these should not be construed as limitations to the scope of the claimed invention, but rather as descriptions of the characteristics of specific embodiments. Certain characteristics described in the context of a single embodiment may also be implemented in combination in a single embodiment. Conversely, various characteristics described in the context of a single embodiment may be implemented individually or in any suitable sub-combination in multiple embodiments. Moreover, although the characteristics may initially be described as functioning in certain combinations, or even initially illustrated as such, in some cases one or more characteristics may be deleted from the combination, and the described combination may be directed to a sub-combination or a variation of a sub-combination. Similarly, although operations are depicted in the illustrations as occurring in a particular order, this should not be understood as requiring that such operations be performed in the specific order shown or in sequential order, or that all depicted operations must be performed to achieve the desired result.

Although the above-described embodiments disclose some examples and implementations, changes, modifications, and enhancements can be made to the described examples and implementations and other implementations based on the disclosed content.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A wireless communication method comprising:
before data transmission between a first wireless communication device and a second wireless communication device, triggering a procedure so that at least one neighboring wireless communication device collects channel information on a plurality of channels and broadcasts the channel information;
in response to receiving the channel information from the at least one neighboring wireless communication device, selecting, by the first wireless communication device, a target channel among the plurality of channels according to the channel information; and
starting data transmission between the first wireless communication device and the second wireless communication device on the target channel.

2. The wireless communication method according to claim 1, wherein
in response to that the at least one neighboring wireless communication device has an ability to include the channel information into feedback packets, receiving, by the first wireless communication device, the feedback packets including the channel information broadcasting from the at least one neighboring wireless communication device; and
in response to that the at least one neighboring wireless communication device does not has the ability to include the channel information into the feedback packets, the at least one neighboring wireless communication device stops broadcasting the channel information back to the first wireless communication device.

3. The wireless communication method according to claim 1, wherein in selecting the target channel, the first wireless communication device analyzes the channel information to determine whether a current channel has lowest load or not.

4. The wireless communication method according to claim 2, wherein the first wireless communication device receives the feedback packets from the at least one neighboring wireless communication device in beacons, in action frame packets, or in NAN (Neighbor Awareness Networking) protocol packets or in BT (blue tooth) packets.

5. The wireless communication method according to claim 1, wherein in collecting the channel information, the at least one neighboring wireless communication device sends probe request and listens on each of the plurality of channels.

6. The wireless communication method according to claim 1, wherein in collecting the channel information, the at least one neighboring wireless communication device sends neighbor report request to a station; and in response to the neighbor report request, the station scans and sends neighbor report response to the at least one neighboring wireless communication device.

7. The wireless communication method according to claim 1, wherein in response that the channel information changes during data transmission, the target channel is changed through a channel switch announcement (CSA) mechanism by the first wireless communication device.

8. A wireless communication device including:
a wireless transceiver module for transmitting and receiving wireless signals; and
a controller coupled to and for controlling the wireless transceiver module,
wherein the controller is configured for:
before data transmission between the wireless communication device and a second wireless communication device, triggering a procedure so that at least one neighboring wireless communication device collects channel information on a plurality of channels and broadcasts the channel information;
in response to receiving the channel information from the at least one neighboring wireless communication device, selecting a target channel among the plurality of channels according to the channel information; and
starting data transmission between the wireless communication device and the second wireless communication device on the target channel.

9. The wireless communication device according to claim 8, wherein
in response to that the at least one neighboring wireless communication device has an ability to include the channel information into feedback packets, receiving the feedback packets including the channel information broadcasting from the at least one neighboring wireless communication device; and
in response to that the at least one neighboring wireless communication device does not has the ability to include the channel information into the feedback packets, the at least one neighboring wireless communication device stops broadcasting channel information back to the wireless communication device.

10. The wireless communication device according to claim 8, wherein in selecting the target channel, the controller is configured to analyze the channel information to determine whether a current channel has lowest load or not.

11. The wireless communication device according to claim 9, wherein the wireless communication device receives the feedback packets from the at least one neighboring wireless communication device in beacons, in action frame packets, or in NAN (Neighbor Awareness Networking) protocol packets or in BT (blue tooth) packets.

12. The wireless communication device according to claim 8, wherein in collecting the channel information, the at least one neighboring wireless communication device sends probe request and listens on each of the plurality of channels.

13. The wireless communication device according to claim 8, wherein in collecting channel information, the at least one neighboring wireless communication device sends neighbor report request to a station; and in response to the neighbor report request, the station scans and sends neighbor report response to the at least one neighboring wireless communication device.

14. The wireless communication device according to claim 8, wherein in response that the channel information changes during data transmission, the target channel is changed through a channel switch announcement (CSA) mechanism by the wireless communication device.
